(19) United States
(12) Patent Application Publication
(10) Pub. No.: US 2003/0023552 A1
(43) Pub. Date: Jan. 30, 2003

(54) Payment processing utilizing alternate account identifiers

(75) Inventors: Peter J. Kight, Alpharetta, GA (US); Hans Daniel Dreyer, Gahanna, OH (US)

Correspondence Address: ANTONELLI, TERRY, STOUT & KRAUS, LLP, Suite 1800, 1330 North Seventeenth Street, Arlington, VA, 22209, US

(73) Assignee: CheckFree Services Corporation

(21) Appl. No.: 10/234,181

(22) Filed: Sep. 5, 2002

Related U.S. Application Data
(63) Continuation-in-part of application No. 09/540,011, filed on Mar. 31, 2000.
Application No. 09/540,011 is a continuation of application No. 09/250,675, filed on Feb. 16, 1999, now abandoned.
Application No. 09/250,675 is a continuation of application No. 08/372,620, filed on Jan. 13, 1995, now Pat. No. 5,873,072.
Application No. 08/372,620 is a continuation of application No. 07/736,071, filed on Jul. 25, 1991, now Pat. No. 5,383,113.

(51) Int. Cl. G06F 17/60

(52) U.S. Cl. 705/40

(57) ABSTRACT

A technique for making a payment for a payor is provided. The technique includes receiving a request to make a payment to a payee for the payor. An account identifier which is associated with a deposit account belonging to the payee is identified based upon processing of the received payment request. The account identifier is not a deposit account number assigned to the deposit account by the financial institution at which the deposit account is maintained. A payment is then directed to the payee's deposit account utilizing the identified account identifier.

### CROSS REFERENCE TO RELATED APPLICATIONS

This application is a Continuation-In-Part of pending U.S. patent application Ser. No. 09/540,011, filed Mar. 31, 2000 and entitled “BILL PAYMENT SYSTEM AND METHOD WITH A MASTER MERCHANT DATA BASE”, which is a continuation of pending prior application Ser. No. 09/250,675, filed Feb. 16, 1999 and entitled “SYSTEM AND METHOD FOR ELECTRONICALLY PROVIDING CUSTOMER SERVICES INCLUDING PAYMENT OF BILLS, FINANCIAL ANALYSIS AND LOANS”, which is a continuation of Ser. No. 08/372,620, filed Jan. 13, 1995 (now U.S. Pat. No. 5,873,072) and entitled “SYSTEM AND METHOD FOR ELECTRONICALLY PROVIDING CUSTOMER SERVICES INCLUDING PAYMENT OF BILLS, FINANCIAL ANALYSIS AND LOANS, which is a continuation of Ser. No. 07/736,071, filed Jul. 25, 1991 (now U.S. Pat. No. 5,383,113) and entitled “SYSTEM AND METHOD FOR ELECTRONICALLY PROVIDING CUSTOMER SERVICES INCLUDING PAYMENT OF BILLS, FINANCIAL ANALYSIS AND LOANS”.

### FIELD OF THE INVENTION

The present invention relates to electronic commerce and more particularly to electronic payment services.

### BACKGROUND OF THE INVENTION

It has been common for many years for consumers to pay monthly bills by way of a personal check written by the consumer and sent by mail to the entity from which the bill or invoice was received. Consumers have used other ways to pay bills, including personally visiting the billing entity to make a cash payment. In today's economy, it is not unusual for a consumer to have several regular monthly invoices to pay. Writing individual checks to pay each invoice can be time-consuming and costly due to postage and other related expenses.

Electronic payment systems have become common. Electronic payment systems make payments on behalf of consumers, thus relieving consumers of the monthly burden of bill payment. Electronic payment systems also make other types of payments on behalf of consumers. Typically, a consumer submits a request to a payment service for the service to make a payment to a payee on behalf of the consumer. The payment request includes, at a minimum, information identifying the payee and an amount of the payment. The payment service receives the payment request, perhaps via telephone, the Internet, or other computing network.

Once a payment request is received, the service provider processes the payment request to complete the payment on behalf of the consumer. This often includes determining a form of payment. Forms of payment include paper and electronic. In paper payment, the service provider prepares either a check or draft and delivers such to the payee. The check is drawn on an account belonging to the service provider. The draft is drawn on an account belonging to the consumer. In payment by check, the service provider must obtain funds from the consumer. In payment by draft, the service provider has no need to obtain funds from the consumer, as no service provider funds are utilized completing the payment to the payee.

In electronic payment, the service provider directs that funds be electronically credited to a demand deposit account belonging to the payee and that funds be electronically debited from a demand deposit account belonging to the consumer. Typically, funds are electronically credited to the payee's account from an account belonging to the service provider, and funds are electronically debited to the service provider's account from the consumer's account. Thus, in both payment by check and electronic payment, the service provider is placed in a position of financial risk. That is, the service provider may not be able to obtain funds from the consumer. This gives rise to the choice of form of payment by the service provider. The choice of payment is often based upon the service provider processing one or more variables associated with a payment request. This processing is known as risk processing or risk management.

Electronic movement of funds is performed by networks linking financial institutes at which the accounts are maintained. The Federal Reserve Automated Clearing House (ACH) Network is an example of one network that provides switch and settlement functionality between financial institutions. In addition to the Federal Reserve, private clearing houses also provide switch and settlement functionality between financial institutions. One such private clearing house, the New York Clearing House (NYCH), has proposed services beyond those of switch and settlement. In particular, a Universal Payment Identification Code (UPIC), which is a universal deposit account identifier associated with a single merchant bank account, has been proposed. The NYCH operates the Electronic Payments Network (EPN) for batch electronic transaction support, and the Clearing House Inter-Bank Payments System (CHIPS) for real-time electronic transaction support, particularly international transactions. Today, the EPN is utilized to process UPIC-based transactions. It is expected that in the future CHIPS will also process UPIC-based transactions.

Some key features of the UPIC are that a same UPIC is always associated with a single deposit account belonging to a merchant. That is, a merchant's UPIC is never deleted or re-used with more than one deposit account. Further, a single merchant having multiple deposit accounts can have multiple UPICs, each one associated with a different one of the deposit accounts. As an added benefit, a UPIC masks the real identity of a merchant's bank account. A UPIC, however, can only be used for credit transactions (deposits to merchants).

A Universal Routing and Transit number (URT) and UPIC are used in place of a bank routing and transit number (RTN) and demand deposit account number (DDA) in electronic transactions. That is, the URT, which is up to eight characters/digits in length, identifies the NYCH system, while the UPIC, which is up to seventeen characters/digits in length, identifies a bank or other financial institution at which a merchant's account is located as well as the merchant's account.

As shown in FIG. 7, a merchant 700 having a UPIC typically solicits a customer 705 to submit payments to merchant 700 using URT/UPIC information. This solicitation is typically through traditional mechanisms for reaching out to customers, whether that be U.S. mail, e-mail, or another avenue. It should be noted that the solicitation assumes the customer 705 can use an electronic payment system 710 to input the URT and UPIC values to remit payment to the merchant 700. It should also be noted that merchant 700 is not necessarily identifying a particular electronic payment system for customer 705 to utilize. The solicitation typically specifically includes the URT identifier and the merchant's UPIC identifier.

As also shown in FIG. 7, to make payments utilizing URT/UPIC information, customer 705 specifically supplies the full URT and UPIC values to an electronic payment system. The necessity of customer 705 supplying URT and UPIC values has several disadvantages. Because of UPIC and URT length and number of digit-character combinations possible, it is very easy for these values to be incorrectly supplied to an electronic payment system by customer 705. It is known from experience that customers often make mistakes in supplying similar data, such as account numbers. Additionally, the time and effort required to supply URT and UPIC values is in and of itself a deterrent to customer 705 supplying this information to the electronic payment system 710. Many customers simply do not wish to take the time or expend the effort to supply this information to their electronic payment system. Thus, adoption of UPIC's as a payment option has been slow to occur. Accordingly, a need exists for a technique to facilitate the use of Universal Payment Identification Codes.

Concurrent with or subsequent to customer 705 supplying URT/UPIC information to the electronic payment system 710, customer 705 submits a payment request to pay merchant 700. The electronic payment system 710 originates an ACH transaction 715. The URT number is placed in the transaction in lieu of a financial institution's routing number, and the UPIC number is placed in the transaction in lieu of the customer's account number. The transaction is either then routed to the Federal Reserve System 720 or EPN 725, depending upon an electronic payment system 710 choice or association. When a URT/UPIC transaction is routed directly to the EPN 725, the EPN 725 performs settlement with the merchant 700. Introduced above, in the future it is expected that such a transaction could be directed to the CHIPS network.

When a URT/UPIC transaction is routed to the Federal Reserve System 720 the transaction is recognized as a URT/UPIC transaction by the Federal Reserve System 720 and is propagated to the EPN 725. The EPN 725 then, as above, performs settlement with the merchant 700.

It should be noted that at present the EPN 725 is only able to provide limited remittance advice data to merchant 700. No provision for rich remittance advice data has been conceived of yet. Accordingly, a need exists for a technique for delivery of rich remittance data when a payment is made utilizing URT/UPIC information.

### OBJECTS OF THE INVENTION

It is an object of the present invention to provide a technique to increase the usage of URT/UPIC-based payments.

It is also an object of the present invention to provide a technique to deliver detailed remittance information when a payment is made utilizing URT/UPIC identifiers.

The above-stated objects, as well as other objects, features, and advantages, of the present invention will become readily apparent from the following detailed description which is to be read in conjunction with the appended drawings.

### SUMMARY OF THE INVENTION

In accordance with the present invention, a database for storing information identifying payees for receipt of electronic payment is provided. A database is a collection of information stored such that related information is stored in association with other related information. The information stored in the database of the present invention pertains to payees which are capable of receiving electronic payment. A payee can be any individual, business, or other organization. In electronic payment, funds are credited to a payee without the need for paper instructions.

The database includes a payee identifier identifying a payee. The payee identifier could be any information which identifies a payee. The payee identifying information could be public information, such as a name, address, or telephone number, in addition to other publicly known payee identifying information. The payee identifying information could also be information other than publicly known information, such as an identifier assigned to the payee by an entity maintaining the database, or even another entity.

The database also includes an account identifier which is associated with a deposit account, such as a checking, savings, or money market account, belonging to the payee. The account identifier is stored such that it is associated with the payee identifier. The account identifier is not a deposit account number assigned to the deposit account by a financial institution at which the deposit account is maintained. It should be noted that the database preferably includes multiple payee identifiers, each identifying a unique payee. Not each one of these unique payees need be associated in the database with an account identifier other than a deposit account number.

In one aspect of the database of the present invention, the account identifier is a Universal Payment Identification Code, known as a UPIC. The UPIC identifies the payee's deposit account and serves as a basis for electronic payments made directly to the payee's deposit account.

According to another aspect of the database, the account identifier is unknown to a payor requesting that payment be made to the payee on behalf of the payor. A payor, which could be an individual, business, or organization, requests that a payment be made to the payee on behalf of the payor. That is, the payor does not deliver funds to the payee. Rather, a third party completes a funds transfer to the payee on behalf of the payor. The payor, in this aspect of the database, does not have knowledge of the account identifier.

In yet another aspect of the database, the database excludes the deposit account number of the payee. That is, the deposit account number assigned to the payee's deposit account by the financial institution at which the account is maintained is not included in the database. It will be appreciated that other payees included in the database could be associated with a deposit account number in the database.

According to still another aspect of the present invention, the account identifier is not assigned by the financial institution at which the account is maintained or an entity which maintains the database, but by another entity.

Also in accordance with the present invention, a method and a system for making a payment on behalf of a payor are provided. A payment made on behalf of a payor is a payment in which a payor requests another entity to make a payment for the payor.

According to one aspect of the method and system for making a payment on behalf of a payor the account identifier is a Universal Payment Identification Code.

According to another aspect of the method and system, the payment request is received and processed by a payment service provider. A payment service provider is an entity which makes payments on behalf of payors.

According to a further aspect of the method and system, the deposit account number is unknown to the payment service provider. Thus, the payment service provider makes payment directly to the deposit account without having knowledge of the deposit account number.

In an especially beneficial aspect of the method and system for making payment on behalf of the payor, the payor does not know the account identifier. Thus, the payment is made based upon an account identifier which is unknown to the payor.

According to yet another aspect of the method and system the account identifier is not assigned by the financial institution at which the account is maintained or an entity receiving the request, but by another entity.

It will also be understood by those skilled in the art that the invention is easily implemented using computer software. More particularly, software can be easily programmed, using routine programming skill, based upon the description of the invention set forth herein and stored on a storage medium which is readable by a computer processor to cause the processor to operate such that the computer performs in the manner described above.

### BRIEF DESCRIPTION OF THE DRAWINGS

In order to facilitate a fuller understanding of the present invention, reference is now made to the appended drawings. These drawings should not be construed as limiting the present invention, but are intended to be exemplary only.

FIG. 1 is a diagrammatical representation of the creation of a consumer database.

FIG. 2 is a diagrammatical representation of the establishment of a merchant's (billing entities) database and the making of payments.

FIG. 3 is a diagrammatical representation of the creation of a consumer pay table.

FIG. 4a is a diagrammatical representation of a payment processing cycle.

FIG. 4b is a continuation of the diagram of FIG. 4a.

FIG. 4c is a continuation of the diagram of FIG. 4b.

FIG. 5 is a diagrammatical representation of a computer hardware system that may be used for accomplishing the present invention.

FIG. 6 is a diagrammatical representation of another computer hardware system that may be used for accomplishing the present invention.

FIG. 7 depicts prior art processing in utilizing URT/UPIC information in making payments.

FIG. 8 depicts processing in utilizing URT/UPIC information in making payments in accordance with the present invention.

FIG. 9 is a simplified depiction of an add payee screen in accordance with the present invention.

FIG. 10 depicts a merchant master file in accordance with the present invention.

FIG. 11 is a further depiction of the payment processing cycle of FIG. 4a showing a determination of a form of electronic payment to be made.

### DETAILED DESCRIPTION OF A PREFERRED EMBODIMENT

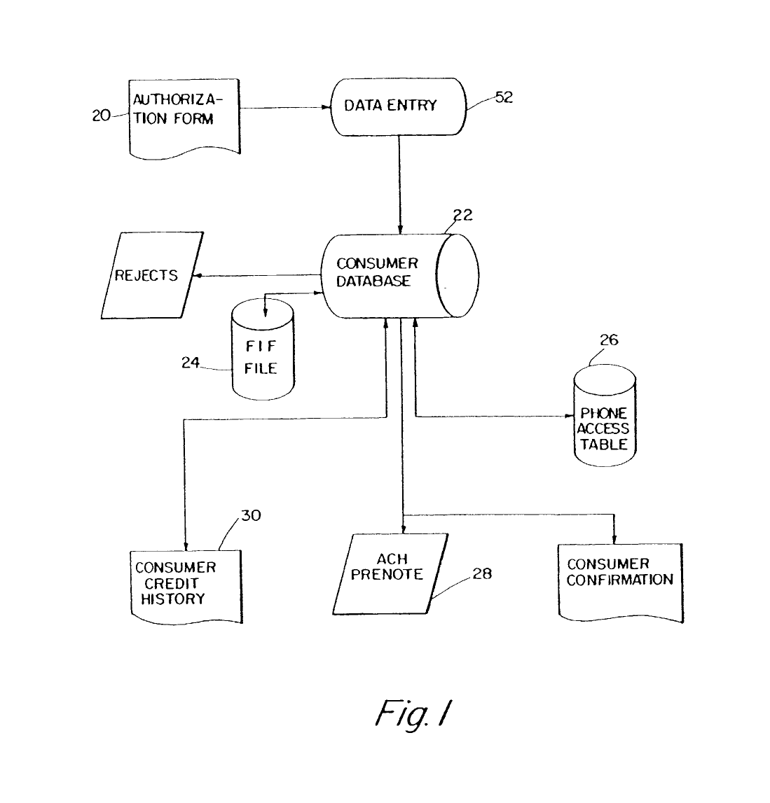

Referring now to the drawings, FIG. 1 illustrates the steps in the creation of a consumer database for use with the present invention. The first step in the process is to establish a consumer's data records on the system. This may be accomplished by the consumer completing an authorization form 20 which would contain the needed information to input into the system concerning the consumer. This information may include the consumer's name, address, telephone number and other applicable information. The consumer may also be required provide a voided check from the consumer's personal checking account. The consumer's information may then be manually input via a keyboard 52 into the consumer database record 22. Alternatively, information could be obtained from the consumer via an on-line session or telephone session.

Default amounts may be set for an individual credit line parameter and for a total month-to-date parameter. These amounts establish the maximum unqualified credit risk exposure the service provider is willing to accept for an individual transaction and for the collective month-to-date transactions of a consumer. As explained herein, the service provider may be at risk when paying a consumer's bills by a check written on the service provider's account or by electronic payment from the service provider's account.

The consumer's bank routing transit and individual account numbers at a financial institution are input into the computer system. This information may be edited against an internal financial institutions file (FIF) database 24 of the present invention. FIF 24 is a database of financial institutions' identification codes and account information for the consumer. This file edits the accuracy of the routing transit number and the bank account number. If the numbers do not correspond with the correct routing and bank numbers, they are rejected and data entry is done again. FIF 24 in conjunction with the software of the present invention also updates the consumer database 22 for both electronic and paper draft routing and account information. The needed information may be obtained from each banking institution and each consumer.

For further security to the service provider, a consumer credit record 30 may be obtained. The default credit limit amounts over which the service provider may be unwilling to assume financial risk may be modified based on the information obtained from the credit report 30.

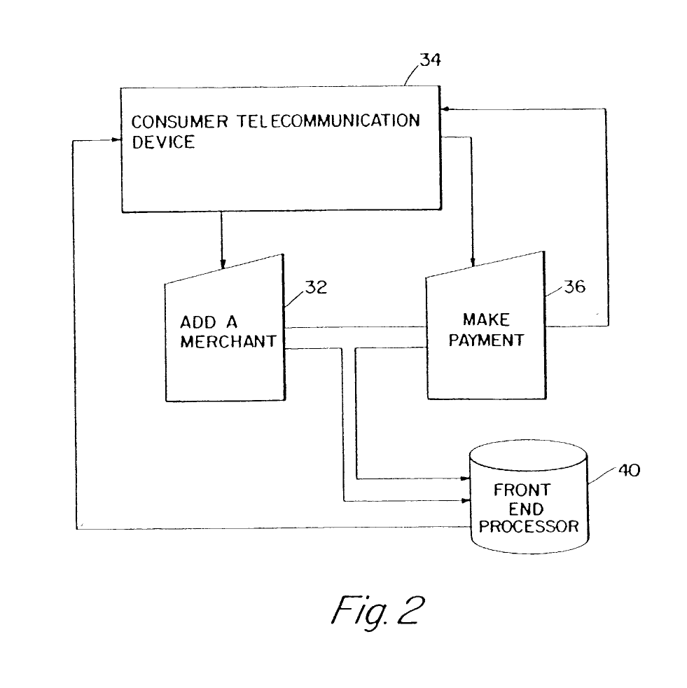

In FIG. 2 the steps are shown for establishing merchants to be paid and the making of a payment. The consumer must inform the service provider or processor of a merchant's name, address, phone number and the consumer's account number with the merchant 32. The term “merchant” as used herein is intended to pertain to any person or entity that the consumer wishes to pay and is not to be limited to the usual merchants most consumers pay, such as the electric company, a home mortgage lender, etc. This information is put into a merchant master file database 42 (MMF). The consumer may also indicate whether the merchant is a variable or fixed merchant. A variable merchant is one in which the date and amount of payment will vary each month. A fixed merchant is one in which the date and amount remain the same each month. If the merchant is fixed, the frequency of payment may be other than monthly, such as weekly, quarterly, etc. The consumer should inform the service-provider of the date on which the merchant is to be paid and the amount to be paid.

Through a telecommunications terminal 34 (e.g., a push-button telephone or computer terminal), a consumer may initiate payment of bills. Through the terminal, the consumer may access his merchant list and input the payment date and amount. The system may be provided with a payment date editor 36 to insure that the date is valid and logical (i.e., payment dates already in the past or possibly a year or more into the future would be questioned). As payments are initiated, a consumer “checkbook register” may be created and automatically updated to reflect this activity. The merchant list can be visible on the consumer's personal computer screen. On a personal computer a consumer may enter merchant payment amounts and payment dates on the computer screen and then transmit this information to the service provider.

By telephone, the list may be presented by programmed voice. The voice may be programmed to ask the consumer if a particular merchant (selected from the consumer's MMF, which may be updated from time to time) is to be paid and to tell the consumer to press 1 if yes, or press 2 if no. If yes, the voice may instruct the consumer to enter the amount to be paid by pressing the numbers on a touch tone phone. The asterisk button could be used as a decimal point. After the amount is entered, the voice may ask the consumer to enter the date on which payment is to be made to the merchant. This may be accomplished by assigning each month a number, such as January being month 01. The consumer may then enter month, day and year for payment. The programmed voice may be accomplished with a VRU (voice response unit) available from AT&T or other vendors. It may communicate with a data processor to obtain consumer information. At the end of the consumer's session on the terminal a confirmation number may be sent to the consumer, providing a record of the transaction.

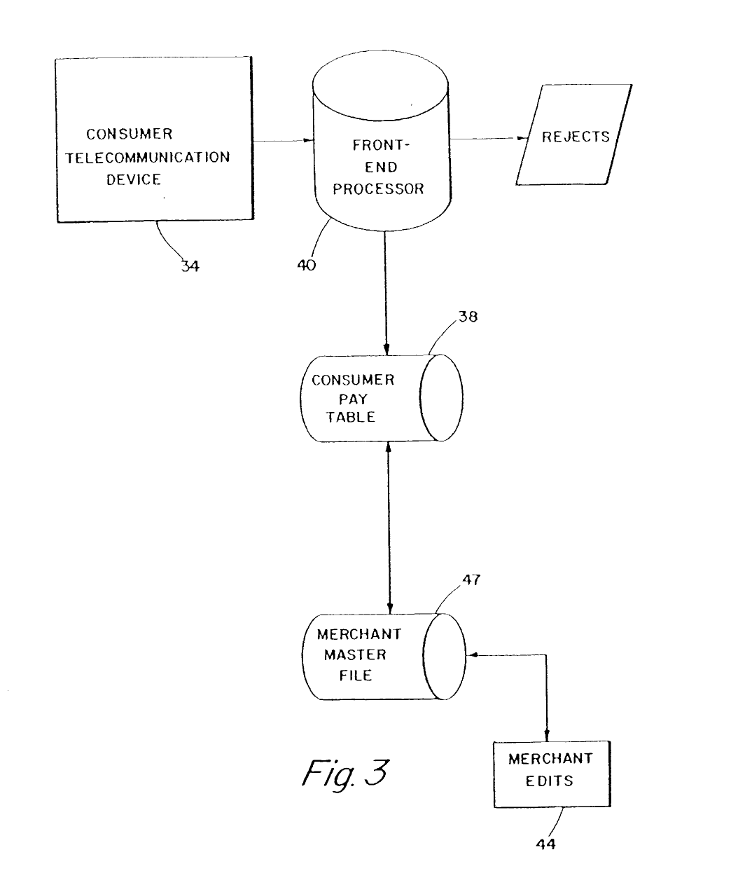

In FIG. 3 the steps are shown for the creation of the consumer pay table 38 and making updates to it. The consumer's files may be received at the service provider on a front end processor 40 that interfaces with the telecommunications network. The consumer's records may be edited 44 for validity by comparing to the merchants' account scheme. Any new merchant records are added to the consumer's pay table. New merchants are compared to the MMF 42 and appropriately cross-referenced to the pay table to check if a merchant record already exists. If no merchant record exists, a merchant record will be created on the MMF 42.

Payment records may also be received on the service provider's processor. The payment may first go through a validation process against the pay table. The validation process checks for duplicate payments and if duplicates are found they are sent to a reject file. The validation process also verifies that merchants are set up and may check for multiple payments to be paid to a particular merchant. Orders for payment go to the consumer pay table to determine when the payment should be released and how it will be released for payment.

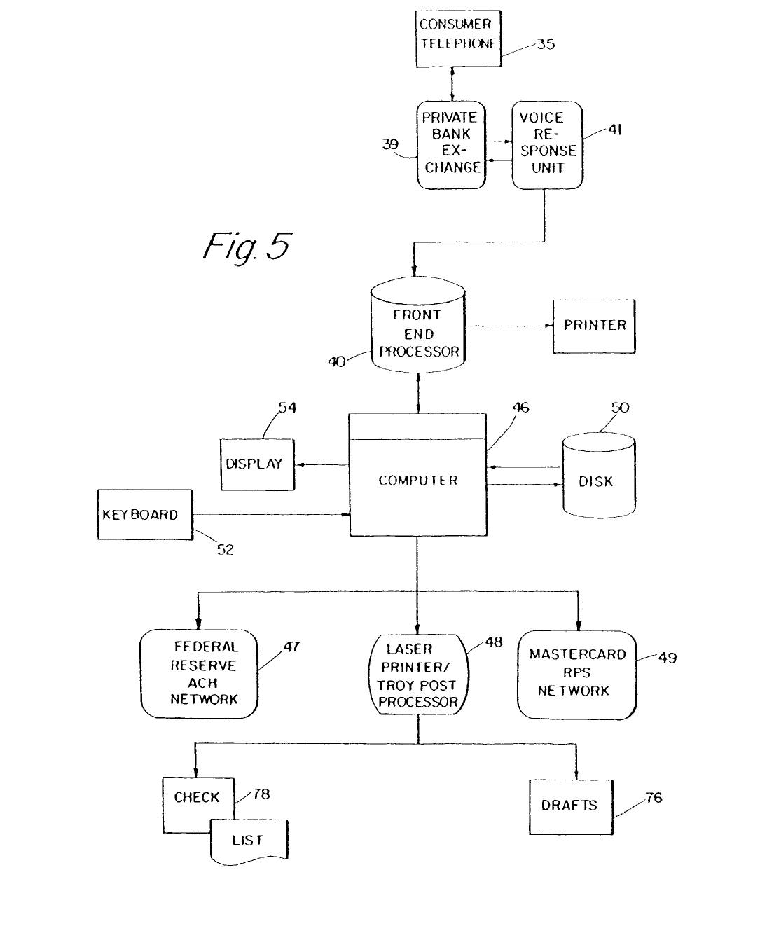

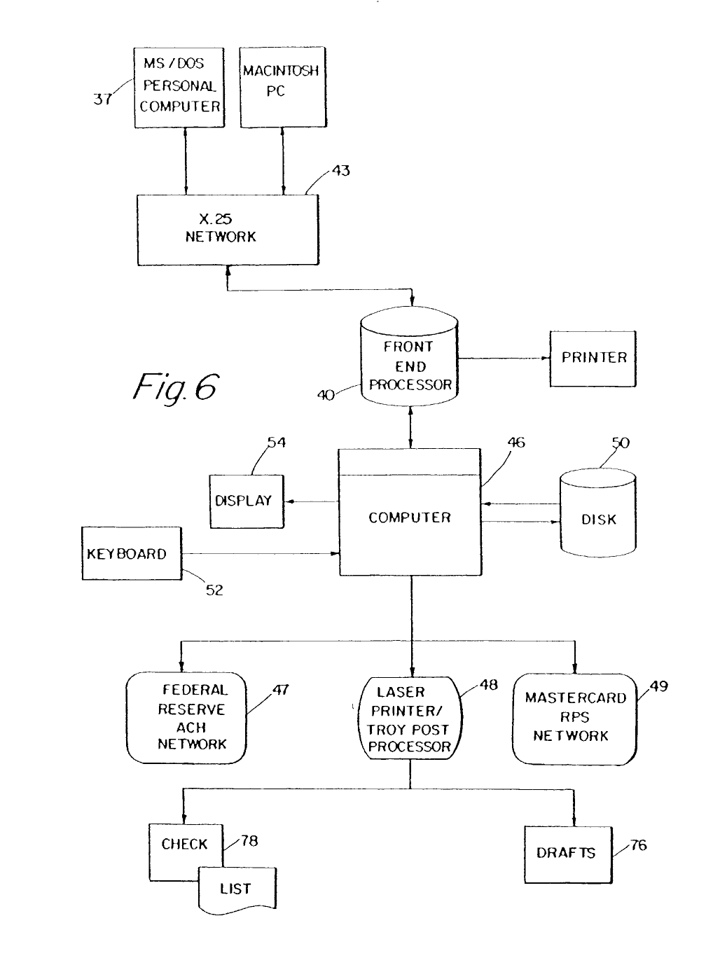

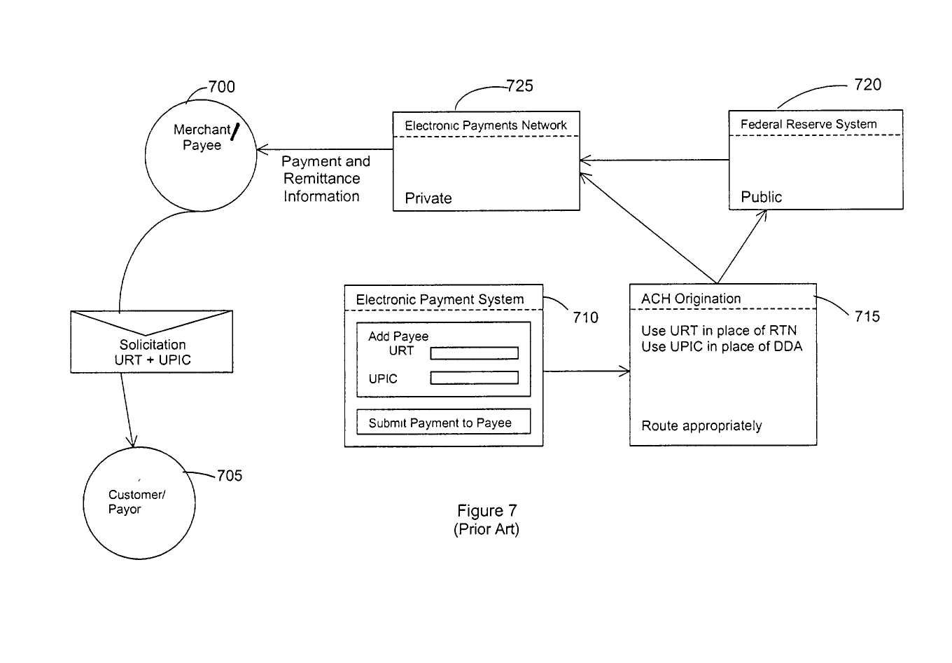

The service provider may pay merchants by a draft or check (paper) or by electronic funds transfer. To create a draft that will pass through the banking system, it must be specially inked. This may be accomplished by a printer which puts a micr code on drafts, like standard personal checks. For example, as shown in FIG. 5, the front end processor 40 may be a DEC VAX which is connected to an IBM main frame 46 Model 4381. Consumers may call by telephone 35, a number that passes through the private bank exchange (PBX) 39 and contacts a voice response unit 41 in association with the front end processor 40. After the consumer's payment instructions are received an analysis is performed to determine the most cost effective and least risk mode of payment for the service provider to use. One preferred mode of payment is electronic funds transfer through the Federal Reserve Automated Clearing House (ACH) Network 47. If the service provider is not a bank, a bank intermediary may be needed to be connected to the Federal Reserve Network. Another payment mode is a charge to the consumer's credit card through the RPS Network 49. Additionally, an IBM Laser Printer attached to a micr post printer 48 may be used by the service provider to send drafts 76 or consolidated checks 78 to merchants. The main frame 46 has data storage means 50 and runs the FIF 24 and MMF 42 programs. It may also have a tape drive or telecommunication interface for accomplishing electronic funds transfer. It should be recognized that various other hardware arrangements could be used to accomplish the present invention. FIG. 6 illustrates a similar arrangement for use when the consumer is using a personal computer 37 to instruct the service provider. The personal computer may access the front end processor 40 through the standard X.25 Network 43.

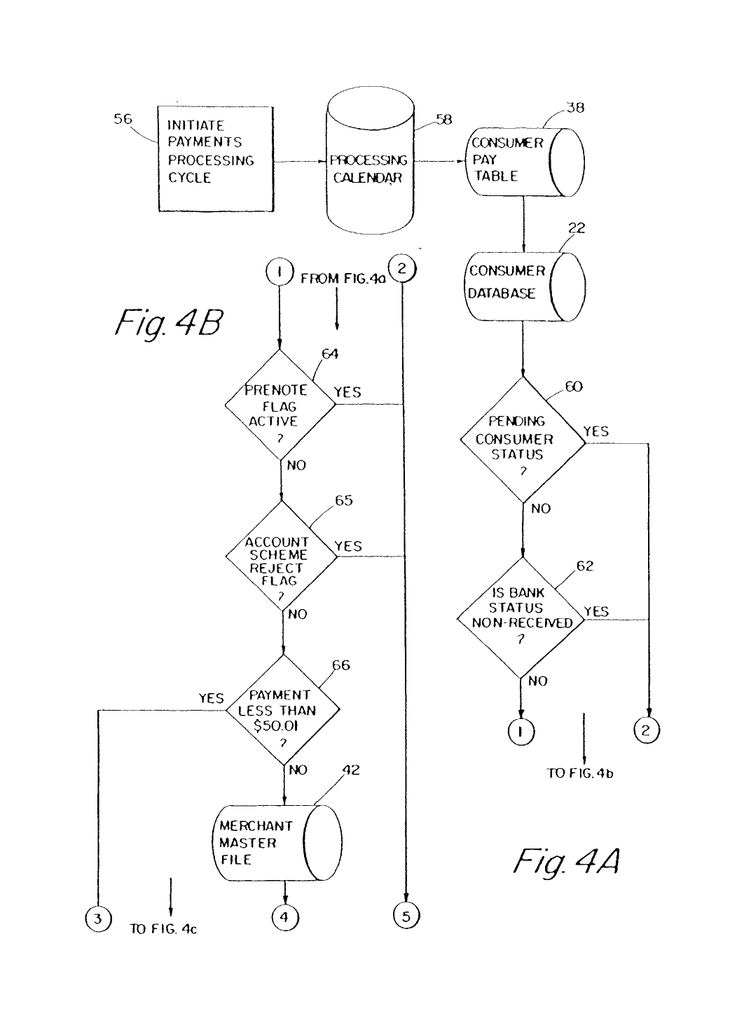

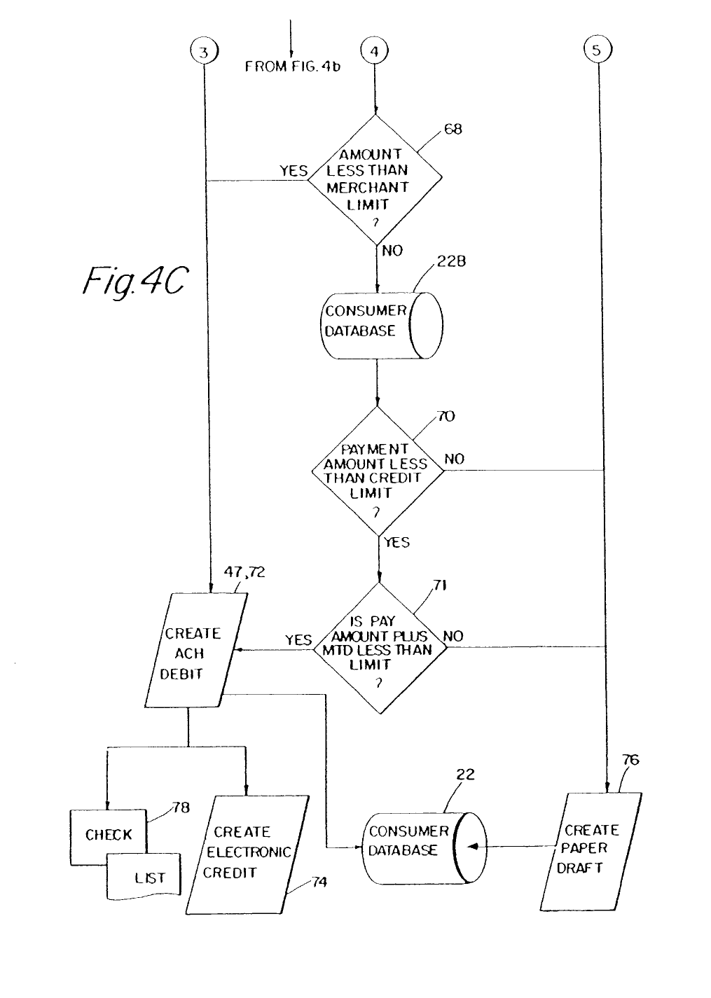

Referring now to FIGS. 4a, 4b and 4c, a payment process is shown. The payment process may be cycled 56 each day or more or less frequently. The first step is to establish when payment items are to be processed. This may be accomplished through a processing calendar 58. A processing calendar 58 may be built into the system. The calendar 58 enables the system to consider each date, including weekends and the Federal Reserve holidays. Payments are released from the consumer pay table 38 using the due date. Any bank date, payments, or payments within a period such as four business days may be released the same day. All future payment dates would be stored in the consumer pay table 38. On-line inquiry may be made on the consumer pay table 38. The service provider has on-line capability to make changes to the consumer payment upon request until the day the payment is released. A consumer's merchant change may also affect the consumer's payment on the pay table 38.

The method of payment to the merchant may be either paper (draft or check) or electronic. There are several factors in the process used to determine if a payment will be released as a paper item, or an electronic transaction. Each consumer may be assigned a status such as: active=good; inactive=bad; and, pending=uncertain, risky. If a consumer's status is pending 60, when reviewing the payment file with the processing calendar 58, the payment should go out as a draft paper to protect the service provider. When payment is made by draft, the service provider is not a contractual party to the transaction. The consumer's bank account codes are actually encoded onto the draft prepared by the service provider and act much like the consumer's personal check. The draft has been specially designed for this process. The draft is payable to either the service provider or the particular merchant. This allows the draft to be delivered to the merchant for payment and depositing, but allows the draft to be legally payable by the bank, with proper authorization. Additionally, posting information for the merchant is contained on the body of the draft. If the consumer's bank transit number does not indicate an electronic bank 62 (i.e., a banking institution that will accept electronic funds transfer), the program associated with FIF 24 sends the payment as a draft. A pre-note 28 is required any time 64 new banking information is entered on a consumer and the bank shows on FIF 24 as an electronic receiving bank. The pre-note period is ten (10) days under federal law. Any payments released during this period are sent as paper.

Another manner in which the service provider may pay bills is by a check written on the service provider's account. A consolidated check may be written if many customers have asked the service provider to pay the same merchant. Under this method of payment the service provider assumes some risk since the service provider writes the check on its own account. The service provider is later reimbursed by the (consumer's) banking institution.

As a means of minimizing risk to the service provider, any transaction may be compared to the MMF 42 credit limit. For example, if the check limit is greater than zero and the payment is $50.00 or less 66, the item may be released as electronic 74 or by service provider check 78. If the payment is greater than $50.00 but less than or equal to the merchant credit limit 68, the payment may be released as electronic payment 74 or check 78. Any payments within the merchant's credit limit 70 are added to the consumer's monthly ACH balance 72. This provides a monthly total billing day to billing day summary of the consumer's electronic payment activity. Any transaction may be compared to the consumer's database credit limit parameters. If a payment amount is greater than the consumer's credit limit, the item is released as a draft 76 which is written on the consumer's account. If the payment amount plus the total of electronic payments in a particular month is greater than the consumer's credit limit, the item is released as a draft 76. Items not released as paper are initiated as an ACH debit against the consumer's account.

The consumer database may be reviewed for proper electronic funds transfer (EFT) routing. Payment to the merchant may be accomplished one of three ways, depending on the merchant's settlement code. Various merchant's settlement codes may be established. For example, a merchant set up with a settlement code “01” results in a check and remittance list 78 being mailed to the merchant. Merchants with a settlement code, such as “10” produce an ACH customer initiated entry (CIE). Merchants with a settlement code, such as, “13” produce a remittance processing system (RPS) credit.

In the consumer pay table, for fixed payments, a payment date gets rolled to the next scheduled payment date on the pay table. The number of remaining payments counter is decreased by one for each fixed payment made. For variable payments once made, the payment date is deleted on the consumer pay table. The schedule date and amount on the consumer pay table roll to zero. A consumer payment history may also be provided which show items such as process date as well as collection date, settlement method, and check number in addition to merchant name and amount.

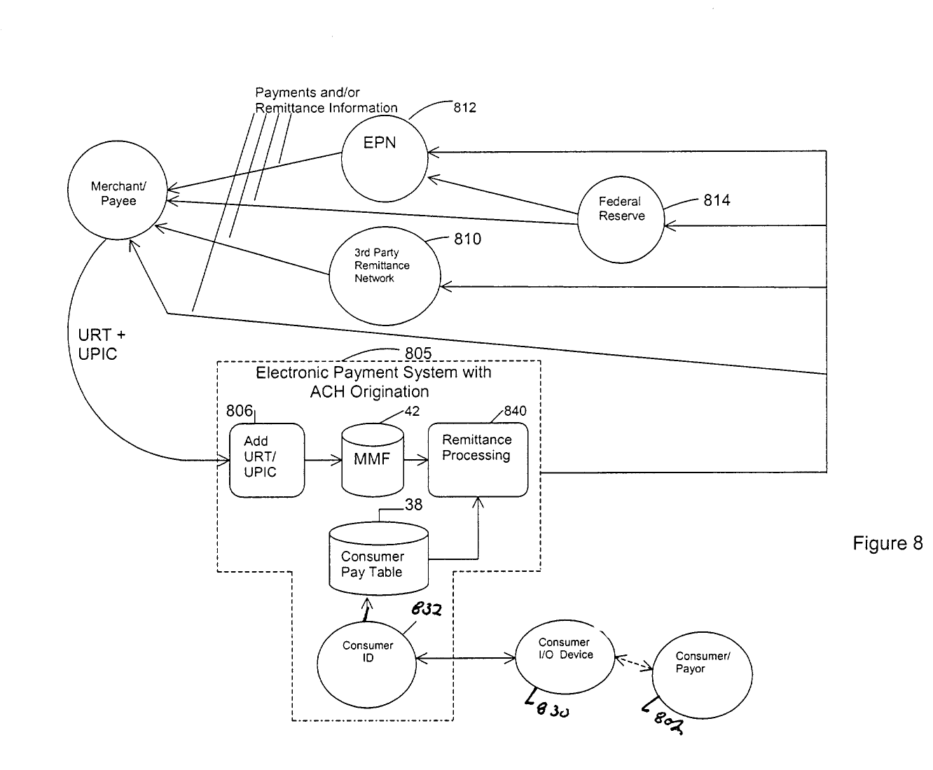

FIG. 8 depicts an inventive technique for making electronic payments utilizing UPIC or other deposit account identifying information instead of payment based solely on deposit account numbers via the ACH network or via credit card. While UPIC based transactions are described below, it should be understood that electronic transactions could be performed utilizing other information than UPIC values, deposit account numbers, or credit card related information. In accordance with this technique, a merchant 801 does not solicit a consumer 802 to use UPIC identifiers, as described earlier. Instead, a relationship is established between the merchant 801 and an electronic payment system 805 that maintains a merchant master file (MMF) 42, introduced above, or other forms of payees. The merchant 801 supplies UPIC information, and optionally URT information, to the electronic payment system 805. Upon receipt, a process to add this data to a new or existing entry for merchant 802 the MMF 42 or other data repository is executed, as shown at 806. It will be appreciated that while the EPN is discussed below the inventive techniques of the present invention will be equally applicable to UPIC-based transactions processed by CHIPS.

Optionally, the merchant 801 may supply remittance direction selection rules to the electronic payment system 805. That is, if the electronic payment system 805 maintains information indicating that remittance advice information and/or payment to merchant 801 can be delivered via multiple delivery channels, including through a third party remittance network 810 other than the EPN 812, directly through the Federal Reserve System 814, through the EPN 812, or delivered directly from the electronic payment system 805 to the merchant 801, rules can be established to allow choice between the different delivery channels.

These rules, as will be recognized from the discussion above, could be based upon one or more of multiple variables. For example, risk could be considered, such that payments above or below certain dollar thresholds could be made utilizing the UPIC value to mask the merchant's bank account number. Also, delivery channel could be determined based upon the amount of remittance advice data to be delivered to the merchant 801, such that a direct to merchant channel could be used when, for instance, the EPN 812 cannot deliver a certain volume or type of remittance advice data. Delivery channel selection could also be based upon least-cost routing. That is, a delivery channel could be chosen dependent upon costs incurred by the electronic payment system 805 in use of various delivery channels.

Shown in FIG. 8, the consumer 802 is using an input/output device 830 which works in conjunction with a consumer user interface 832 provided by the electronic payment system 805, or some entity (not shown) working closely with the electronic payment system 805. The input/output device could be phone, computer, or other device. It should be noted that whenever consumer 802 identifies merchant 801 to the electronic payment system 805, whether that be in an add payee request or a payment request, there is no need for the consumer 802 to specify the merchant's URT/UPIC information, or even be aware of such information.

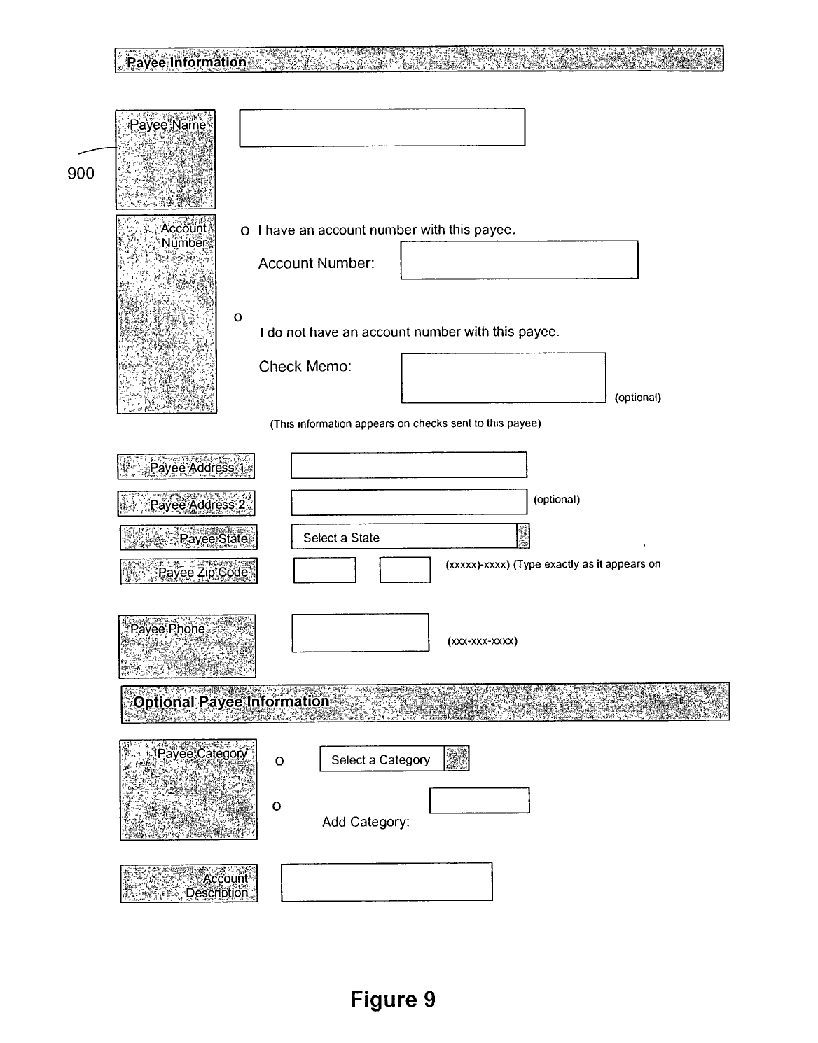

FIG. 9 depicts an add payee page 900 that could be completed by consumer 802 in identifying merchant 801 to the electronic payment system 805. As shown in this example, although a number of different types of information may be required of the consumer 802, there is no provision for providing the payee's bank account information, or even a proxy for that bank account information, such as URT/UPIC information. This is in contrast to the prior art processing described above, in which a customer must provide URT/UPIC information.

In the present embodiment, the consumer's add payee requests, as well as payment requests, are written to the consumer pay table 38, discussed above, before remittance processing 840 is initiated. Of course, it will be recognized that add payee requests and/or payment requests could immediately, in real-time, be subjected to processing, or stored in one or more data repositories other than the consumer pay table 38 for later processing. Certain aspects of remittance processing 840 will be further discussed below. Information from the consumer pay table 38 and the MMF 42 are processed together to determine delivery channels for electronic payments, i.e., the Federal Reserve system 814, the EPN 812, a third party remittance network 810, or to the merchant directly. As will be understood from the discussion above, if the Federal Reserve System 814 receives a transaction that has URT/UPIC information, the transaction is simply propagated to the EPN 812.

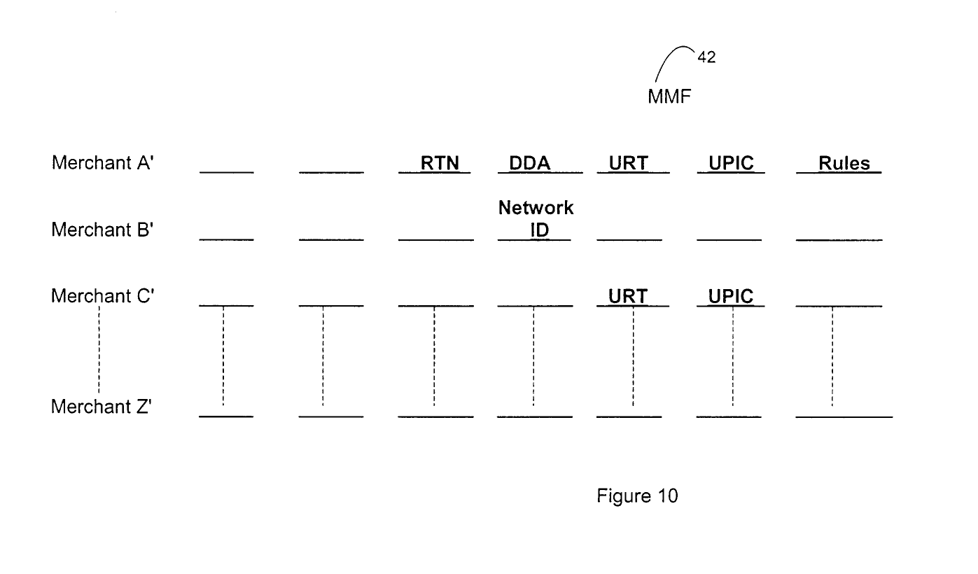

FIG. 10 is an simplified exemplary depiction of the MMF 42. Shown are entries for merchants A′ through Z′. Each entry includes information associated with a merchant. As shown, information associated with merchant A′ includes bank routing (RTN) and account identifying (DDA) information. This RTN/DDA information identifies a deposit account belonging to merchant A′. Also associated with merchant A′ is URT/UPIC information. Delivery channel selection rules are also associated with merchant A′. Based upon these selection rules, one or more delivery channels can be chosen.

Information associated with merchant B′ includes a network ID. This network ID designates a third party remittance network, for example the MasterCard RPP network. As this is the only delivery channel information stored in association with merchant B′, the only delivery channel for electronic payments available is the identified third party remittance network.

Information associated with merchant C′ includes URT/UPIC information. As this is the only delivery channel information stored in associated with merchant C′, the only delivery channels available for electronic payments are the EPN and the Federal Reserve System in conjunction with the EPN.

It should be noted that the merchant master file 42 may contain additional information associated with merchants, including addresses. For those merchants for which address information is stored, payment could be made by a check or draft delivered to the stored address, as will be understood from the discussion above.

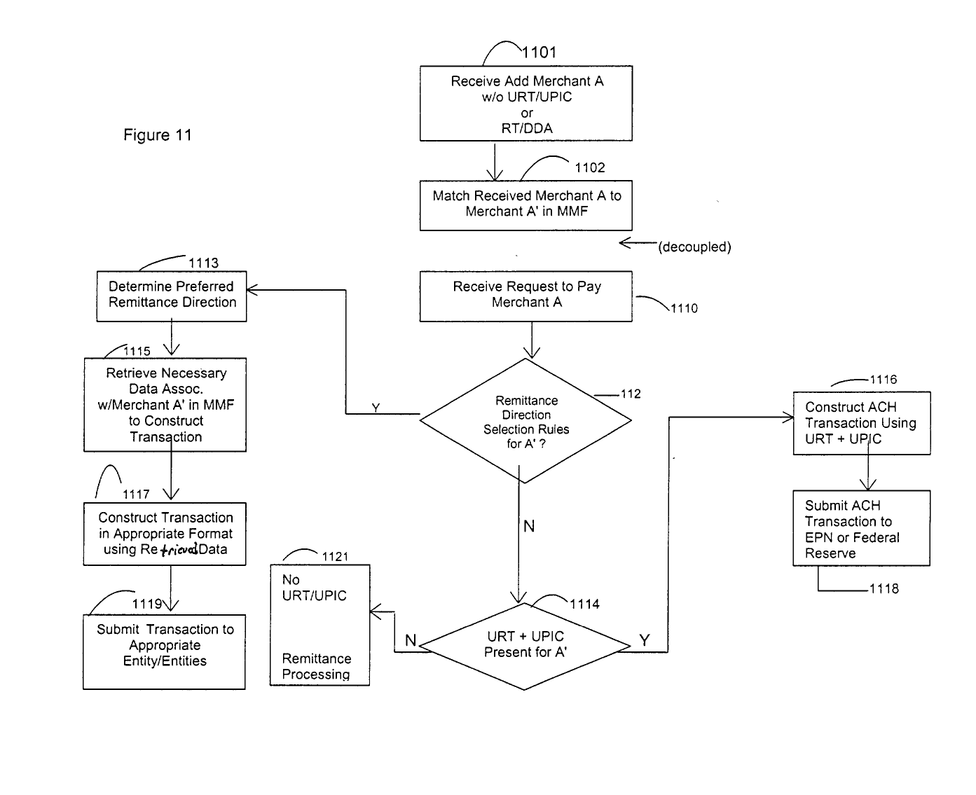

FIG. 11 shows an exemplary logic flow of remittance processing 840 performed by the electronic payment system 805, introduced above. As shown in step 1101, the consumer 802 requests to add merchant A to her or his payee list. It again should be stressed that this request does not include either URT/UPIC or RTN/DDA information. The add merchant request is matched with information associated with the merchant A′ contained in the MMF 42, step 1102. At the very least, stored information associated with merchant A′ includes the merchant's URT/UPIC information. At some point in time, perhaps along with the add merchant request, or separate, the customer 802 requests that a payment be made to the merchant A on the customer's behalf, step 1110. After receiving the payment request, the above-described determination of form or payment (electronic or paper) is made (not shown in FIG. 11). It will be appreciated that alternatively, any time UPIC information is associated with a merchant, all payments to that merchant could be made utilizing URT/UPIC information.

This example assumes that the determination is to make payment electronically. Once this determination is made, a determination is made as to whether or not there are remittance direction selection rules for the merchant A′ stored in the MMF 42, step 1112. If so, operations continue with step 1113, discussed below. If not, a determination is made as to whether or not URT/UPIC information is stored in the MMF 42 in association with the merchant A′. If URT/UPIC information is stored, then, at step 1116, an electronic transaction is constructed using the URT information in lieu of a RTN and the UPIC information in lieu of a DDA. The constructed transaction is then submitted to either the EPN 812 or the Federal Reserve system 814, step 1118.

If in step 1114 it is determined that URT/UPIC information is not stored in the MMF 42, a ‘no URT/UPIC’ remittance processing is invoked, step 1121. This processing can result in either directing payment via a third party remittance network 810, or constructing a transaction utilizing RTN/DDA information and submitting the constructed transaction directly to the Federal Reserve system, with perhaps remittance advice directly to the merchant A, or via another channel.

This ‘no URT/UPIC’ remittance processing is shown in FIG. 5 at detail 46, entitled COMPUTER. FIG. 5 specifically shows payment being made via either the Federal Reserve ACH network 47, or the MasterCard RPS network 49, which is an example of a third party remittance network.

If at step 1112 it is determined that there are remittance direction selection rules for merchant A′ stored in the MMF 42, the next step is to determine preferred delivery channel(s) using the rules and the specifics of the received payment request, step 1113. As discussed above, examples of factors could influence the choice of channel include the complexity of the data associated with the payment request, i.e., it may be preferable that rich remittance advice be directed directly to the merchant A. Another example is the amount of the payment, i.e., payments below a certain amount threshold could be directed via the Federal Reserve 814 with merchant account information unmasked, while payments above a certain amount threshold could be directed through the EPN 812, with the merchant account information masked with UPN/UPIC information. Also, as discussed above, some sort of least cost routing analysis could be performed.

At step 1115 information associated with the merchant A′ in the MMF 42 necessary to construct a transaction is retrieved. This necessary information is received in accordance with the determined delivery channel(s). For example, if the transaction will be directed via the EPN 812, the URT/UPIC information would be specifically retrieved. If the transaction will be directed solely via the Federal Reserve 814, RTN/DDA information would be retrieved. If the transaction will be directed via a third party network 810, a merchant A′ identifier for the network will be retrieved.

At step 1117 the transaction, in a format appropriate for the particular delivery channel, is constructed using the retrieved data. The constructed transaction is submitted to the appropriate entity, i.e., Federal Reserve 814, EPN 812, third party network 810, or merchant 801. It should be understood that different portions of the transaction, for example, the fund settlement portion and the remittance advice portion, could be directed to different entities.

Accordingly, payments can be directed using URT/UPIC information without a consumer having a need to input these values either at the time of adding a merchant or requesting payment. Furthermore, funds and/or remittance advice can be selectively delivered using the most beneficial delivery channel in view of various cost and non-cost related factors.

The present invention is not to be limited in scope by the specific embodiments described herein. Indeed, various modifications of the present invention in addition to those described herein, will be apparent to those of skill in the art from the foregoing description and accompanying drawings. Thus, such modifications are intended to fall within the scope of the appended claims.

What is claimed is:

1. A database for storing information identifying payees for receipt of electronic payment, comprising:
a payee identifier identifying a payee; and
an account identifier associated with a deposit account of the payee, the account identifier being other than a deposit account number, stored associated with the payee identifier.

2. The database of claim 1, wherein the account identifier is a Universal Payment Identification Code.

3. The database of claim 1, wherein:
the account identifier is unknown to a payor requesting that payment be made to the payee on behalf of the payor.

4. The database of claim 1, wherein the database excludes the payee deposit account number.

5. The database of claim 1, wherein the account identifier is assigned by an entity other than a financial institution at which the deposit account is maintained or an entity maintaining the database.

6. A method for making a payment on behalf of a payor, comprising:
receiving a request to make a payment to a payee on behalf of a payor;
processing the received payment request to identify an account identifier associated with a deposit account of the payee, the account identifier being other than a deposit account number of the payee deposit account; and
directing payment to the payee deposit account based upon the identified account identifier.

7. The method of claim 6, wherein the account identifier is a Universal Payment Identification Code.

8. The method of claim 6, wherein the payment request is received and processed by a payment service provider.

9. The method of claim 8, wherein the deposit account number is unknown to the payment service provider.

10. The method of claim 6, wherein the account identifier is unknown to the payor.

11. The method of claim 6, wherein the account identifier is assigned by an entity other than a financial institution at which the deposit account is maintained or the entity receiving the request.

12. A system for making a payment on behalf of a payor, comprising:
a communications interface configured to receive a request to make a payment to a payee on behalf of a payor; and
a processor configured to identify an account identifier associated with a deposit account of the payee, the account identifier being other than a deposit account number, and to direct payment to the payee deposit account based upon the identified account identifier.

13. The system of claim 12, wherein the account identifier is a Universal Payment Identification Code.

14. The system of claim 11, wherein the payment request is received by a payment service provider.

15. The system of claim 14, wherein the deposit account number is unknown to the payment service provider.

16. The system of claim 12, wherein the account identifier is unknown to the payor.

17. The system of claim 11, wherein the account identifier is assigned by an entity other than a financial institution at which the deposit account is maintained or an entity receiving the request.
